(19) United States
(12) Patent Application Publication
(10) Pub. No.: US 2012/0138701 A1
(43) Pub. Date: Jun. 7, 2012

(54) Electrospray Dispensing System

(76) Inventors: Marc X. Olivier, Salt Lake City, UT (US); Stephen C. Jacobsen, Salt Lake City, UT (US)

(21) Appl. No.: 12/959,177

(22) Filed: Dec. 2, 2010

(51) Int. Cl. B05B 5/025

(52) U.S. Cl. 239/3; 239/690

(57) ABSTRACT

An electrospray dispensing system for delivering a controllable quantity of charged micro-droplets of a conductive fluid, and which includes an elongate fluid supply cylinder having a first end, a second end, a sidewall (e.g., forming a circular or other polygonal cross-section) between the first and second ends, and an interior hollow that is in fluid communication with a source of conductive fluid. The dispensing system also includes an array of selectively-activated capillary tubes having proximal ends that are in fluid communication with the interior hollow and distal ends extending radially outward through the sidewall, and which are configured so that any conductive fluid flowing outwardly through one or more activated capillary tubes is electrically-charged. The dispensing system further includes a grounding electrode that is in electrical communication with a source of ground and located at a predetermined distance from the distal ends of the capillary tubes, so that an electric potential between the charged conductive fluid and the grounding electrode will cause each of the activated capillary tubes to form a cone jet which projects a stream of charged micro-droplets towards the grounding electrode.

### FIELD OF THE INVENTION

The present invention relates generally to the field of electrospray systems, and more particularly to electrospray dispensing systems, such as can be used for fuel injectors.

### BACKGROUND OF THE INVENTION AND RELATED ART

The method of using a high voltage electric field to atomize a liquid flowing through a narrow nozzle into a mist of small, uniformly-sized and charged droplets has been known in the art for nearly a century. Originally known as electrohydrodynamic atomization, the electric field is created by connecting a conductive capillary tube to one side of an electric circuit to form a hollow electrode through which a conductive fluid must pass. As the fluid travels the length of the capillary, either under the influence of back pressure or through capillary action, it can acquire a charge. At the outlet of the capillary tube the fluid collects to form a convex meniscus, wetting the entire circumference of the capillary outlet. A counter-electrode, connected to ground, is placed some distance away from the capillary tip to complete the electric field.

The electrohydrodynamic process is highly-dependent on the strength of the electric field, and hence the voltage differential between the capillary electrode and the counter electrode. If the voltage is not high enough, the fluid will merely grow at the tip of the capillary tube to form a drop that eventually drips off. However, if the voltage is significantly strong the interaction between the conductive fluid and the electric field will cause the fluid at the capillary tip to form into a cone pointing towards the counter electrode. The electric field then imposes sheer forces on the surface of the cone, forcing the outer layers of fluid to slough off and form a microjet directed towards the counter-electrode. The velocity of the microjet fluid is quite fast, on the order to 10 to 50 meters/second. As the microjet fluid travels away from the capillary tip it begins to break up into fine droplets having a uniform size, with each droplet maintaining the strong electric charge it picked up while traveling through the capillary tube.

If a hole or passage is located in the counter-electrode and aligned with the microjet, the droplets will pass through the counter electrode into the space beyond. During this passage the individual droplets give up both a significant portion of their charge and a large percentage of their velocity. However, the droplets retain enough charge so that when their forward velocity stops, they begin to interact by repelling any nearby droplets having the same like charge, which prevents the individual droplets from coalescing into larger drops. This results in a fine mist of uniformly sized and charged droplets which can be utilized in a variety of ways.

This process of electrohydrodynamic atomization is commonly referred to as electrospray, and has many practical applications. It has been utilized in the application of thin film coatings for semiconductors and thick film coatings with inkjet printing and powder deposition. It has also found use in the medical field as a nebulizer for the delivery of medication. And as a source of ionization, in which ions present in the liquid are transformed into gas phase ions through the process of atmospheric pressure ionization, electrospray is notably combined with the analytical technique of mass spectrometry to form electrospray ionization-mass spectrometry. This method enjoys nearly universal application for chemical analysis, finding wide use in chemical manufacturing, analytical chemistry, environmental chemistry, and perhaps most importantly in the life sciences, where it plays a central role in pharmaceutical drug discovery and development.

### SUMMARY OF THE INVENTION

In accordance with one embodiment described herein, an electrospray dispensing system is provided for delivering a controllable quantity of charged micro-droplets of a conductive fluid. The dispensing system includes an elongate fluid supply cylinder having a first end, a second end, a sidewall extending between the first and second ends, and an interior hollow that is in fluid communication with a source of conductive fluid. The dispensing system also includes an array of selectively-activated capillary tubes having proximal ends that are in fluid communication with the interior hollow and distal ends extending radially outward through the sidewall, and which are configured so that any conductive fluid flowing outwardly through one or more activated capillary tubes is electrically-charged. The dispensing system further includes a grounding electrode that is in electrical communication with a source of ground and located at a predetermined distance from the distal ends of the capillary tubes, so that an electric potential between the charged conductive fluid and the grounding electrode will cause each of the activated capillary tubes to form a cone jet which projects a stream of charged micro-droplets towards the grounding electrode.

In accordance with another embodiment described herein, an electrospray dispensing system is provided for delivering a controllable quantity of charged micro-droplets of a conductive fluid. The dispensing system includes a base substrate having a plurality of selectively-activated electrospray nozzles formed therein, and one or more activated electrospray nozzles which further comprise a capillary tube formed through the base substrate having a proximal end in fluid communication with a source of conductive fluid, a distal end, and a solid guide wire that is coaxially disposed at least partially within the capillary tubes to form an annular passage, and having a distal tip of the guide wire projecting beyond the distal end of the capillary tube. Furthermore, at least one of the capillary tube and guide wire is conductive and in electrical communication with a high-voltage source so as to electrically charge the conductive fluid flowing through the annular passage. The dispensing system also includes a grounding electrode that is in electrical communication with a source of ground and located a predetermined distance from the distal tips of the guide wires, so that a voltage differential between the charged conductive fluid and the grounding electrode draws the charged fluid away from the distal end of each of the activated capillary tubes to form a cone jet about the distal tip of the guide wire which projects an outwardly-directed stream of charged micro-droplets.

In accordance with yet another embodiment described herein, a method is provided for delivering a controllable quantity of charged micro-droplets of a conductive fluid. The method includes placing an interior hollow of an elongate cylindrical body in fluid communication with a source of conductive fluid, with the cylindrical body having a first end, a second end, and a sidewall extending between the first and second ends enclosing the interior hollow. The method also includes drawing the conductive fluid through one or more activated capillary tubes in an array of selectively-activated capillary tubes, each having proximal ends in fluid communication with the interior hollow and distal ends extending radially outward through the sidewall, and imparting the conductive fluid in the activated capillary tube with an electric charge. The method further includes creating an electric potential between the charged conductive fluid and an elongate tubular grounding electrode that is in electrical communication with a source of ground and surrounding the elongate cylinder body at a predetermined distance from the distal ends of the capillary tubes, to form an injector annular passage having an open end. The method also includes forming a cone jet about the distal end of each activated capillary tube that projects a stream of charged micro-droplets into the injector annular passage.

### BRIEF DESCRIPTION OF THE DRAWINGS

Features and advantages of the invention will be apparent from the detailed description that follows, and which taken in conjunction with the accompanying drawings, together illustrate features of the invention. It is understood that these drawings merely depict exemplary embodiments of the present invention and are not, therefore, to be considered limiting of its scope. And furthermore, it will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings, in which:

FIG. 1 is a cut-away perspective view of an electrospray dispensing system, in accordance with one representative embodiment;

FIG. 2 is a cross-sectional perspective view of an electrospray dispensing system, in accordance with another representative embodiment;

FIG. 3 is a cross-sectional perspective view of an electrospray dispensing system, in accordance with yet another representative embodiment;

FIG. 4 is a cross-sectional perspective view of an electrospray dispensing system, in accordance with yet another representative embodiment;

FIG. 5 is a cross-sectional perspective view of an electrospray dispensing system, in accordance with yet another representative embodiment;

FIG. 6 is a cross-sectional perspective view of an electrospray dispensing system, in accordance with yet another representative embodiment;

FIG. 7 is a cut-away perspective view of an electrospray dispensing system, in accordance with yet another representative embodiment;

FIG. 8 is a perspective view of an electrospray dispensing system, in accordance with yet another representative embodiment; and

FIG. 9 is a flowchart depicting a method for delivering a controllable quantity of charged micro-droplets of a conductive fluid.

### DETAILED DESCRIPTION OF EXEMPLARY EMBODIMENTS

The following detailed description makes reference to the accompanying drawings, which form a part thereof and in which are shown, by way of illustration, various representative embodiments in which the invention can be practiced. While these embodiments are described in sufficient detail to enable those skilled in the art to practice the invention, it should be understood that other embodiments can be realized and that various changes can be made without departing from the spirit and scope of the present invention. As such, the following detailed description is not intended to limit the scope of the invention as it is claimed, but rather is presented for purposes of illustration, to describe the features and characteristics of the representative embodiments, and to sufficiently enable one skilled in the art to practice the invention. Accordingly, the scope of the present invention is to be defined solely by the appended claims.

Furthermore, the following detailed description and representative embodiments of the invention will best be understood with reference to the accompanying drawings, wherein the elements and features of the embodiments are designated by numerals throughout.

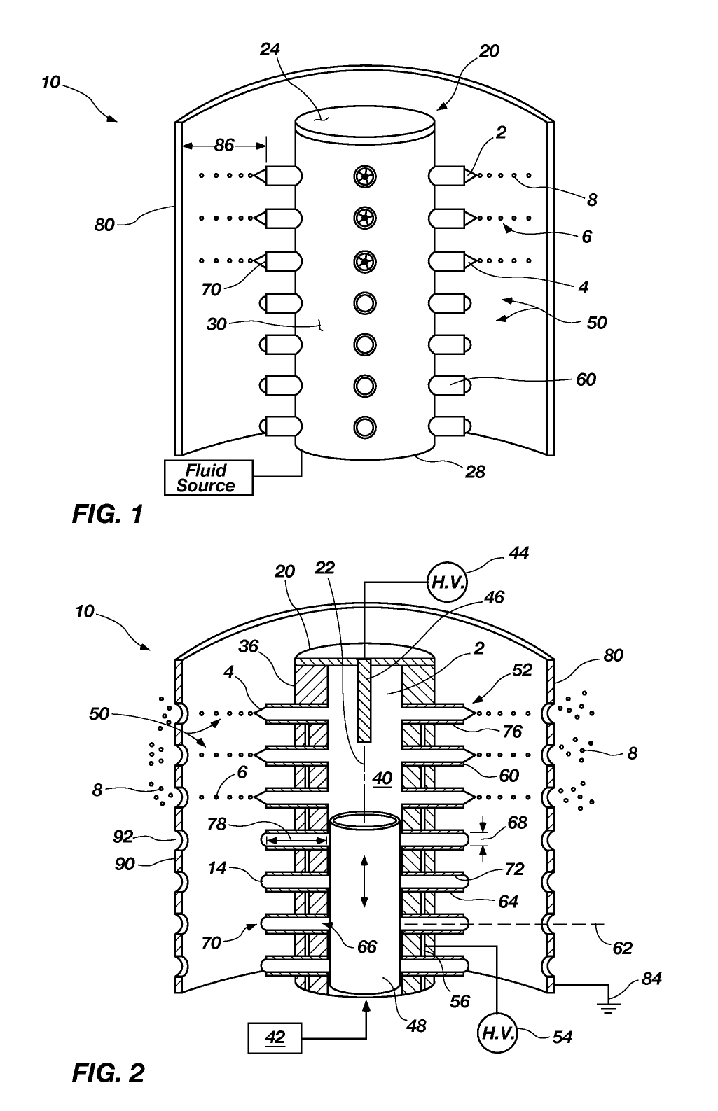

Illustrated in FIGS. 1-9 are several exemplary embodiments of an electrospray dispensing system for delivering a controllable quantity of charged micro-droplets of a conductive fluid, and which embodiments include one or more methods for delivering the controllable quantity of charged micro-droplets. As described herein, the dispensing system provides several significant advantages and benefits over other devices and methods which may be used to deliver charged droplets of a conductive fluid. However, the recited advantages are not meant to be limiting in any way, as one skilled in the art will appreciate that other advantages may also be realized upon practicing the various embodiments of the electrospray dispensing system.

With reference to FIG. 1, illustrated therein is one representative embodiment of an electrospray dispensing system 10 for delivering a variable and controllable quantity of charged micro-droplets 8 of a conductive fluid 2. The dispensing system 10 includes an elongate fluid supply cylinder 20 having a first end 24, a second end 28, a sidewall 30 extending between the first and second ends and an interior hollow in fluid communication with a source of conductive fluid. In the embodiment shown, the fluid supply cylinder 20 comprises a circular cross-section. Other cross-sections are contemplated as discussed below.

The dispensing system 10 also includes and supports via the fluid supply cylinder 20 a multi-layer radial array 50 of selectively-activated capillary tubes 60 having proximal ends in fluid communication with the interior hollow and distal ends 70 extending radially through the sidewall 30 of the fluid supply cylinder 20, and wherein a portion of the conductive fluid 2 entering the proximal end and flowing outwardly through one or more activated capillary tubes is electrically-charged. The dispensing system 10 further includes a grounding electrode 80 disposed about the fluid supply cylinder 20 and radial array 50 of capillary tubes 60 that can be in electrical communication with a source of ground, and which is located at a predetermined distance 86 from the distal ends of the capillary tubes. When one or more capillary tubes are activated, an electric potential between the charged conductive fluid and the grounding electrode causes each of the one or more activated capillary tubes to form a cone jet 4 that projects a stream 6 of charged micro-droplets 8 towards the grounding electrode 80.

Furthermore, the radial array 50 of selectively-activated capillary tubes 60 can be scalable, so that the total number of capillary tubes included in the electrospray dispensing system 10 can be increased by extending the length of the fluid supply cylinder 20, wherein the number of layers or rows of capillary tubes 60 is increased.

In accordance with one embodiment, an interior cross-sectional view of the electrospray dispensing system 10 is shown in FIG. 2, which illustrates the interior hollow 40 of the fluid supply cylinder 20 that is in fluid communication with the source of conductive fluid 42 and filled with the conductive fluid 2. In various aspects the conductive fluid 2 can include a variety of conductive fluids or liquids as used in the various electrospray applications described above, and can further include low-conductive and non-conductive liquids that have been treated with a conductive agent. For example, fuel injectors are one potential application for the electrospray dispensing system 10 described herein, and common fuels having a natural conductivity that is too low for use with the electrospray dispensing system, such as JP-8, can have an antistatic agent, such as DuPont/Octel Stadis 450, blended into the fuel as an additive.

As illustrated with more detail in FIG. 2, the capillary tubes 60 can each comprise a tubular body 64 of internal diameter 68 having a proximal end 66 and a distal end 70, and with a longitudinal center axis 62. The capillary tubes 60 can be quite small, and in one embodiment, can have internal diameters 68 ranging from about 50 μm to about 200 μm. The proximal ends 66 of each capillary tube 60, whether active or inactive, can open into the interior hollow 40 of the fluid supply cylinder 20 so that the conductive fluid 2 flows freely into the capillary tubes when uncovered. The capillary tubes 60 can be of sufficient length 78 in relation to their diameters 68 so that the conductive fluid 2 flows naturally from the proximal ends 66 to the distal ends 70 under the influence of capillary action, and forms a meniscus of the fluid at the distal ends of the capillary tubes, and with little to no hydrostatic pressure within the interior hollow 40. Nevertheless, in one aspect the source of conductive fluid 42 can also provide the conductive fluid 2 within the interior hollow 40 with a hydrostatic pressure which can be modulated to control the flowrate of the conductive fluid through the capillary tubes 60. Once the interior passages of the capillary tubes 60 have been filled with conductive fluid 2, however, the same surface tension forces which create the capillary action that draws the fluid to the distal end 70 of the tubular body 64 can also operate to prevent the conductive fluid 2 from flowing further out of the distal ends 70 of the capillary tubes without some externally-applied force.

Also shown in FIG. 2, in one aspect the material forming the tubular bodies 64 of the capillary tubes 60 can be configured to have an affinity with respect to the conductive fluid 2 (configured to permit or facilitate wetting of the tubular bodies (similar to a hydrophilic material or coating with respect to water)), or the inside surface 72 of the capillary tubes 60 can be covered with a layer or coating that has an affinity to the conductive fluid, so as to attract and draw the conductive fluid through the capillary passages and wet the distal end 70 of the capillary tube. In contrast, the outer surfaces 76 of the tubular bodies and/or the outer surface 36 of the fluid supply cylinder 20 can be covered with a layer or coating that is resistant to wetting of the conductive fluid, so as to repel the conductive fluid 2 away from the outer surfaces and keep it from pooling or forming undesirable drops on other portions of the electrospray dispensing system 10 (similar to a hydrophobic layer or coating with respect to water). Some possible examples of a wetting resistant coating include, but are not limited to polytetrafluoroethylene (PTFE), Parylene, nanostuctured titania or zirconia powder particles. Further, these wetting resistant coatings may be applied to the metallic electrode surface by different techniques, including plasma spraying, combustion flame spraying, high velocity oxy fuel spraying, and other methods.

As stated above, the dispensing system 10 further includes a grounding electrode 80 that is in electrical communication with a source of ground 84, and which is located at a predetermined distance from the distal ends of the capillary tubes. When one or more of the selectively-activated capillary tubes 60 are activated, an electric potential between the charged conductive fluid 2 and the grounding electrode 80 causes each of the one or more activated capillary tubes to form a cone jet 4 that projects a stream of charged micro-droplets 8 towards the grounding electrode 80. In one aspect the grounding electrode 80 can include a grounding sheet 90 having one or more apertures or thru-passages 92 formed therein and aligned with the array 50 of capillary tubes for allowing the passage of the micro-droplet stream 6. For instance, the grounding sheet 90 can comprise a thin foil of metallic material having a plurality of thru-holes 92 cut therein using a mechanical, laser or chemical cutting or etches process, etc., and which foil sheet can then be supported at the predetermined distance from the distal tips 70 of the capillary tubes 60.

It is to be appreciated that the radial array 50 of selectively-activated capillary tubes 60 can be activated in a variety of ways, including mechanical or electrical activation and/or variations thereof. As shown in FIG. 2, for instance, the capillary tubes 60 can be mechanically activated and de-activated through the movements of a cylindrical sleeve 48 that translates back and forth within the interior hollow 40 to uncover or cover the proximal ends 66 of the conductive tubes 60 to allow or prevent, respectively, the conductive fluid from entering the proximal ends 66 of the tubular bodies 64. The cylindrical sleeve 48 can have a substantially thin wall thickness with respect to the outer diameter of the sleeve (or inner diameter interior hollow) so as to minimize the volume of fluid that is displaced as the sleeve moves back and forth within the interior hollow 40.

Additionally, the conductive fluid 2 enclosed within the interior hollow 40 of the elongate fluid supply cylinder 20 and/or within the array 50 of capillary tubes 60 can be provided with an electric charge in a variety of ways. For instance, in one aspect a charging electrode 46 in electrical communication with an interior hollow high voltage source 44 can be located inside the interior hollow 40, so as to provide the entire body of conductive fluid inside the interior hollow 40 and within the passages of the radial array 50 of capillary tubes 60 with the electric charge at the same time. The electric charge can be maintained at a substantially constant level as the cylindrical sleeve 48 translates back and forth within the interior hollow 40 and selectively activates rows or banks 52 of capillary tubes 60. Furthermore, in one aspect the charging electrode 46 can be located along the longitudinal axis 22 of the fluid supply cylinder 20 so as to maintain contact with the conductive fluid 2 without interfering with the movements of the translating cylindrical sleeve 48. As the conductive fluid is charged from a central source or charging electrode 46, the tubular bodies 64 of the capillary tubes 60 may or may not be conductive.

In another aspect, a plurality of conductive pathways or vias 56 can be provided that electrically connect the plurality of capillary tubes 60 (which can be formed from a conductive material or have a conductive interior surface 72) with an array high voltage source 54, so that the conductive fluid is electrically-charged as it flows through the activated capillary tube. As can be seen in FIG. 2, a plurality of capillary tubes 60 can be connected in series to the array high voltage source 54, so that all of the conductive capillary tubes 60 in the radial array 50 are electrified simultaneously, and so that the selective-activation of the various rows or banks 52 of capillary tubes 60 is still provided by the translating cylindrical sleeve 48. However, means other than the translating cylindrical sleeve 48 for selectively-activating the capillary tubes 60 are also possible.

For instance, illustrated in the cross-sectional perspective view of FIG. 3 is another embodiment 100 of the electrospray dispensing system in which an array 150 of selectively-activated capillary tubes 160 is formed within the sidewall 130 of an elongate fluid supply cylinder 120 bounded by a first end 124 and a second end 128 and having an interior hollow 140 in fluid communication with a source 142 of conductive fluid 102. As with the embodiment described above, each of the selectively-activated capillary tubes 160 can have a proximal end 166 in fluid communication with the interior hollow and a distal end 170 extending radially outward through the sidewall 130, so that the conductive fluid 102 flowing outwardly through an activated capillary tube is electrically-charged. The electrospray dispensing system 100 also includes a grounding electrode 180 in electrical communication with a source of ground 184 and located at a predetermined distance 186 from the distal ends 170 of the capillary tubes 160.

Instead of mechanical activation, however, the banks 152 of selectively-activated capillary tubes 160 can be electrically isolated from each other by arranging the conductive pathways or vias 156 so that each bank or sub-set of rows can be independently activated and de-activated, respectively, by closing or opening various switches which connect the banks of capillary tubes to the array high-voltage source 154. Thus, as shown in FIG. 3, the upper bank 152a of capillary tubes can be activated through the closing of switch 158a, while the lower bank 152b of capillary tubes can remain deactivated through the opening of switch 158b.

As may be appreciated, the elongate fluid supply cylinder 120 and array 150 of selectively-activated capillary tubes 160 can be scalable to include hundreds of capillary tubes 160 extending through the sidewalls 130 of the fluid supply cylinder 120, with each bank or group of capillary tubes 152a, 152b electrically isolated from the others and being selectively-activated with an electronic switching device 158a, 158b, so that the activation and deactivation of each bank is only limited by the speed of the electronic switching devices. Thus, in one aspect the plurality of banks or groups of capillary tubes 152a, 152b can be activated separately or in combination to project controllable, incremental amounts of the conductive fluid towards the grounding electrode 180.

The electrical activation of the electrospray dispensing system 100 shown in FIG. 3 may be more effective with a fluid that is only moderately conductive, so that the electrical charging taking place within the activated capillary tube is localized, and is not also conveyed back to the reservoir of conductive fluid filling the interior hollow 140 with sufficient strength to inadvertently create cone jets in the adjacent and non-activated capillary tubes that are in fluid (and electrical) communication with the interior hollow.

The grounding electrode 180 can further comprise an elongate tubular body or shell 190 surrounding the elongate fluid supply cylinder and forming an injector annular passage 182 having an open end 194 and an end 196 opposite the open end 194. As stated above, in one aspect the tubular body or shell 190 of the grounding electrode 180 can have a plurality of holes or thru-passages formed therein for allowing the passage of the micro-droplet streams 106 projected from the distal ends 170 of the activated capillary tubes to pass through the grounding electrode prior to complete evaporation of the micro-droplets. However, if the pre-determined distance 186 between the distal ends 170 of the capillary tubes and the grounding electrode is large in comparison to the size of the micro-droplets 108 of conductive fluid, the micro-droplets can be completely evaporated into vapor prior to reaching the grounding electrode which can be a solid tubular body or shell 190 without the holes or thru-passages, as shown in FIG. 3. Additionally, a source of compressed air 198 can be placed in fluid communication with the end 196 with the injector annular passage 182 opposite the open end, and configured to provide an air flow 188 which blows the vapor and evaporating micro-droplets 8 out the open end 194 of the injector annular passage and into a larger chamber or unbounded volume where the gaseous mixture of the air and conductive fluid vapor can be utilized in a variety of applications.

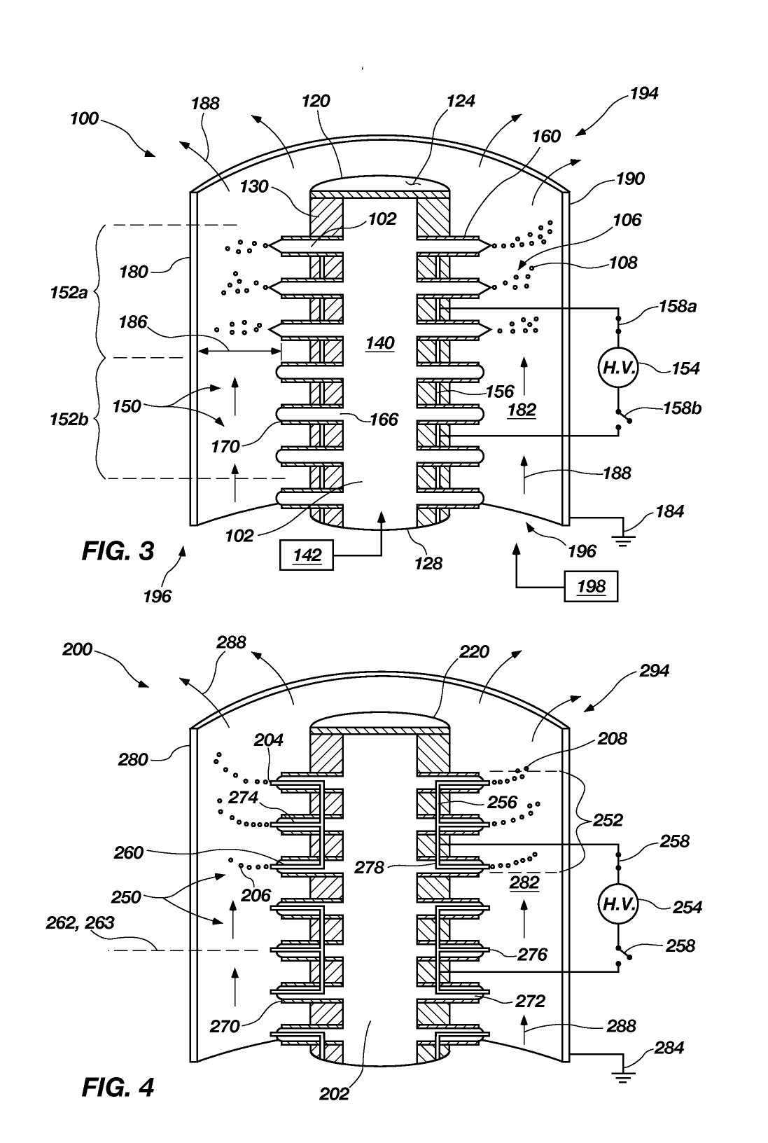

Another representative embodiment 200 of the electrospray dispensing system is shown in FIG. 4, in which one or more of the plurality of selectively-activated capillary tubes 260 forming the radial array 250 can include a solid guide wire 274 that is coaxially disposed at least partially within the capillary tube 260 to form a nozzle annular passage 272, and which guide wire 274 also has a distal tip 276 that projects beyond the distal end 270 of the capillary tube 260. In the representative embodiment shown in FIG. 4, the base portion 278 of the guide wires 274 can extend through a sidewall of the capillary tubes 260 to secure the guide wire in a position and orientation that is substantially centered and coaxial within longitudinal axis 262 the capillary tube. In some aspects, moreover, the guide wires 274 can be formed from a conductive material and placed in electrical communication with a high-voltage source 254, so as to electrically charge the conductive fluid 202 flowing through the nozzle annular passages 272. For instance, as can also be seen in FIG. 4, the conductive pathways 256 can connect the bases 278 of the guide wire together into groups or banks 252 of capillary tubes which can be individually activated and de-activated, respectively, by closing or opening the electronic switching devices 258 which connect the banks of capillary tubes 252 to the high-voltage source 254. Alternatively, all of the guide wires can be connected into a single electric circuit for the simultaneous charging of the conductive fluid in all of the capillary tubes which can be selectively-activated with a translating cylindrical sleeve, similar to that shown in FIG. 2.

The distal tip 276 of the solid guide wire 274 can extend or project beyond the distal end 270 of the capillary tube 260 a distance this is substantially greater than or equal to the internal diameter of the capillary tube, so as to extend beyond the furthest potential radius of a naturally-forming meniscus of the conductive fluid. This can ensure that the cone jet of conductive fluid 204 forms about the end face of the distal tip 276 of the guide wire 274, and not about the outlet opening of the capillary tube. Because the surface area of the end face is much smaller than the area of the outlet opening, the cone jet which forms about the end face of the guide wire can be much smaller in size than cone jets formed about the capillary tube without guide wires, resulting in a corresponding reduction in the surface tension forces which must be overcome prior to establishing the stream of charged micro-droplets.

Forming the smaller cone jet 204 about the end face of the guide wire 274 can be advantageous by reducing the size of the stream of charged micro-droplets 206 to an average diameter between about 5 μm to about 30 μm. As can be appreciated by one of skill in the art, the time for evaporation of a drop or droplet of fluid is proportional to the square of its diameter, so that halving the diameter of a drop or droplet results in a four-fold increase in the evaporation rate. Thus, as stated above, in one aspect of the electrospray dispensing system 200 the stream 206 of charged micro-droplets 208 can be configured to evaporate prior to reaching the grounding electrode 280, and can be swept up in the flow of air 288 passing perpendicular to the array 250 of selectively-activated capillary tubes and out the opening 294 of the injector annular passage 282.

Various additional aspects of the selectively-activated capillary tubes 260 having solid guide wires 274 positioned therein are described in more detail in commonly owned and copending U.S. patent application Ser. No. ______, filed ______, and entitled ELECTROSPRAY DELIVERY DEVICE (Attorney Docket No. 2865-25036), which application is incorporated by reference in its entirety herein.

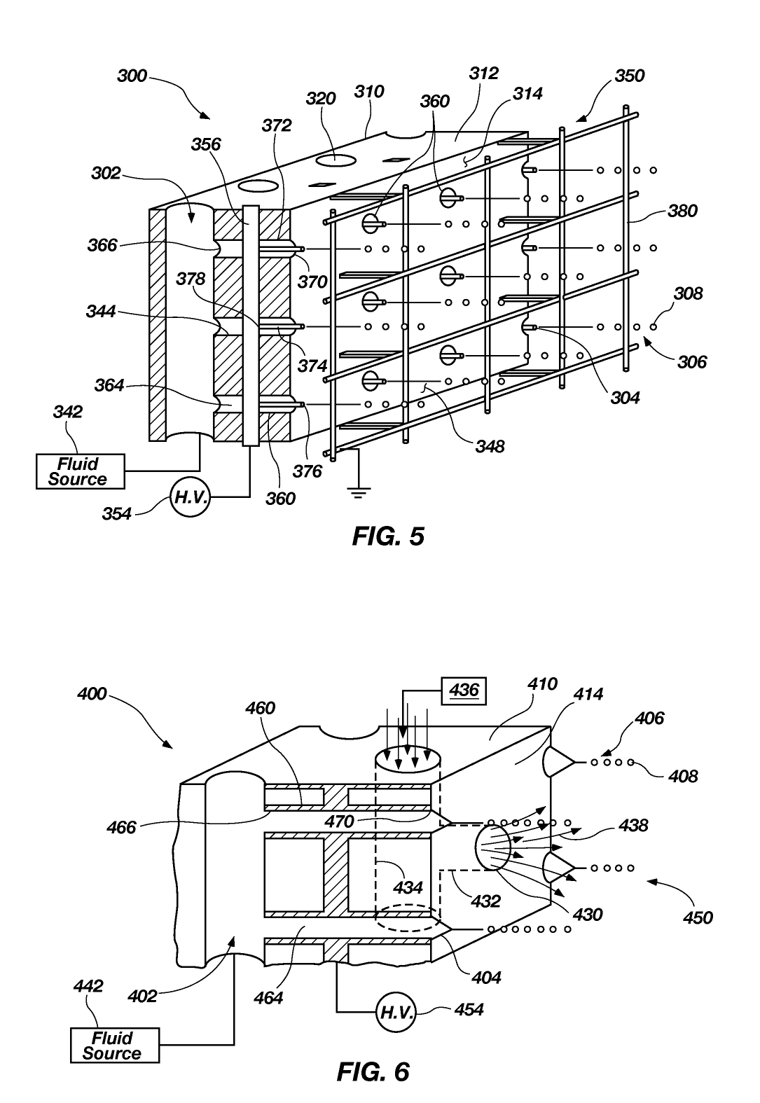

FIG. 5 illustrates yet another representative embodiment 300 of an electrospray dispensing system for delivering a controllable quantity of charged micro-droplets of a conductive fluid. The electrospray dispensing system 300 comprises an array 350 of selectively-activated capillary tubes 360, each having a proximal end 366 in fluid communication with a fluid supply cylinder that is in fluid communication with a source of conductive fluid 342, and a distal end 370 opposite the proximal end and directed towards a grounding electrode 380. Each capillary tube 360 can also include a solid guide wire 374 at least partially disposed, and supported to be, within the capillary tube to form a nozzle annular passage 372, with the guide wire having a distal tip 376 projecting beyond the distal end 370 of the capillary tube. At least one of the capillary tube 360 and guide wire 374 can be conductive and in electrical communication with an array high-voltage source 354 so that the conductive fluid 302 receives an electric charge as it flows through the nozzle annular passage 372 and wets the distal tip 376 of the guide wire 374.

In contrast to the previously-described embodiments having capillary tubes formed from a defined tubular body, however, each of the capillary tubes 360 in the electrospray dispensing system 300 can instead comprise a passage or channel 364 formed through a common base substrate 310 that is built up from one or more layers of material, such as base layer 312 and outer layer 314, etc.

A grounding electrode 380 or grid that is in electrical communication with a source of ground can be spaced at a predetermined distance from the outer surface 314 of the base substrate 310 or the distal tips 376 of the guide wires 374. The high-voltage source 354 can be selectively activated so that a voltage differential between the charged conductive fluid and the grounding electrode can draw the conductive fluid away from the distal end 370 of the capillary tube to form a cone jet 304 about the end face of the distal tip 376, and from the apex of which is discharged a jet or stream 306 of charged micro-droplets 308.

As may be appreciated by one of skill in the art, an electrospray dispensing system 300 having one or more passages or channels 364 formed through an insulating or non-conductive base substrate 310 that has been built up from one or more layers of material, and with conductive features such as the guide wire 374 and conductive passages or vias 356 embedded therein, can lend itself to the readily-available MEMS (MicroElectroMechanical Systems) materials and manufacturing techniques, including physical and chemical deposition, lithography and etching. However, other materials, configurations and manufacturing techniques are also possible and may be considered to fall within the scope of the present invention.

Each capillary tube 360 or passage 364 can be of sufficient length in comparison to its diameter so that once connected to the source of conductive fluid 342, the liquid flows naturally from the proximal end 366 to the distal end 370 under the influence of capillary action to form a meniscus at the distal end of the tube, and with little to no hydrostatic pressure at the source of conductive fluid. Nevertheless, in one aspect the source of conductive fluid 342 can also have a hydrostatic pressure which can be modulated to control the flowrate of the conductive fluid 302 through capillary tube.

While the one or more material(s) forming the base substrate 310 can be non-conductive and insulating, in one aspect the passage or channel 364 forming the capillary tube 360 can be lined with a layer/coating 344 of conductive material, as well as one that has an affinity to the fluid, or that facilitates wetting (similar to a hydrophilic material or coating with respect to water). In the conductive case, the material can be placed in electrical communication with the high-voltage source 354. In the case of the layer/coating 344 facilitating wetting with respect to the conductive fluid, it can attract and help draw the conductive fluid 302 from the source of conductive fluid 342 and through the annular passage 372 to the distal end 370 of the capillary tube.

With the embodiment of FIG. 5, the base portion 378 of the solid guide wire 374 can be embedded within the base substrate 310, and can extend through the internal sidewall of the channel or passage 364 to be supported coaxially within the capillary tube 360. The material forming the guide wire 374 may also be configured to be conductive and/or to facilitate wetting with respect to the conductive fluid 302 (similar to a hydrophilic material or coating), and can be placed in electrical communication with the high-voltage source 354 in the conductive case. If able to facilitate wetting, the material forming the guide wire 374 may also attract and help draw the conductive fluid through the annular passage 372 and wet the distal tip 376 of the guide wire.

Furthermore, as also illustrated in FIG. 5, the outer surface 314 of the base substrate 310 can be covered with a layer or coating 348 that is resistant to wetting with respect to the conductive fluid, so as to repel the conductive fluid away from the outer surface 314 and keep it from pooling or forming otherwise undesirable drops on other portions of the electrospray dispensing system 300.

The array 350 of selectively-activated capillary tubes 360 can be configured to deliver a controllable quantity of charged micro-droplets 308 of the conductive fluid 302. For instance, any one of the capillary tubes 360 and/or guide wires 374 can be conductive and individually connected to the high-voltage source 354 and configured for selective activation, so that a stream 306 of charge micro-droplets 308 can be produced from a first activated capillary tube and not from an inactive second capillary tube adjacent to the first. Furthermore, the array of selectively-activated capillary tubes 360 can be scalable to include tens or even hundreds of capillary tubes formed into the base substrate 310, and which can be group together in discrete groupings or banks in various configurations or arrays that are selectively controllable to deliver a pre-determined incremental amount of conductive fluid depending on the number of capillary tubes/banks that are activated at any one instant in time.

Shown in FIG. 6 is another representative embodiment 400 of the electrospray dispensing system that includes one or more gas duct openings 430 interspersed within and around the array 450 of selectively-activated capillary tubes 460, so as to provide an outwardly-directed flow 438 of compressed air or gas which can be substantially parallel with the streams 406 of charged micro-droplets 408 being drawing away from the distal ends 470 of the capillary tubes. As described above, in one aspect the capillary tubes 460 can be narrow thru-passages or channels 464 formed into one or more base layers 410 having proximal ends 466 which are in fluid communication with a source of conductive fluid 442. The capillary tubes 460 or channels can be configured so that the conductive fluid 402 is drawn from the proximal end 466 to the distal end 470 of the capillary tube under capillary action, and at which point a voltage differential between the electrically-charged conductive fluid and a grounding electrode (not shown, but as described above) can cause a cone jet 404 to form at the distal end of the capillary tube and project the stream 406 of charged micro-droplets towards the grounding electrode.

The outwardly-directed flow 438 of compressed air or gas exiting the one or more gas passage openings 430 can be beneficial by removing any excess conductive fluid from off the outer surface 414 of the base substrate 410, and by creating a turbulent gas flow adjacent the streams 406 that helps to break up and evaporate the charged micro-droplets 408. With the embodiment 400 illustrated in FIG. 6, the gas duct openings 430 can be outlets from short air duct stubs or gas passages 432 that are in fluid communication with primary gas passages 434, and which in turn are fluidly coupled to a source of compressed air or gas 436. However, other configurations and arrangements for the directing the flow of the compressed air or gas through the base substrate 410 (or a sidewall) are also possible, and can be considered to fall within the scope of the present invention.

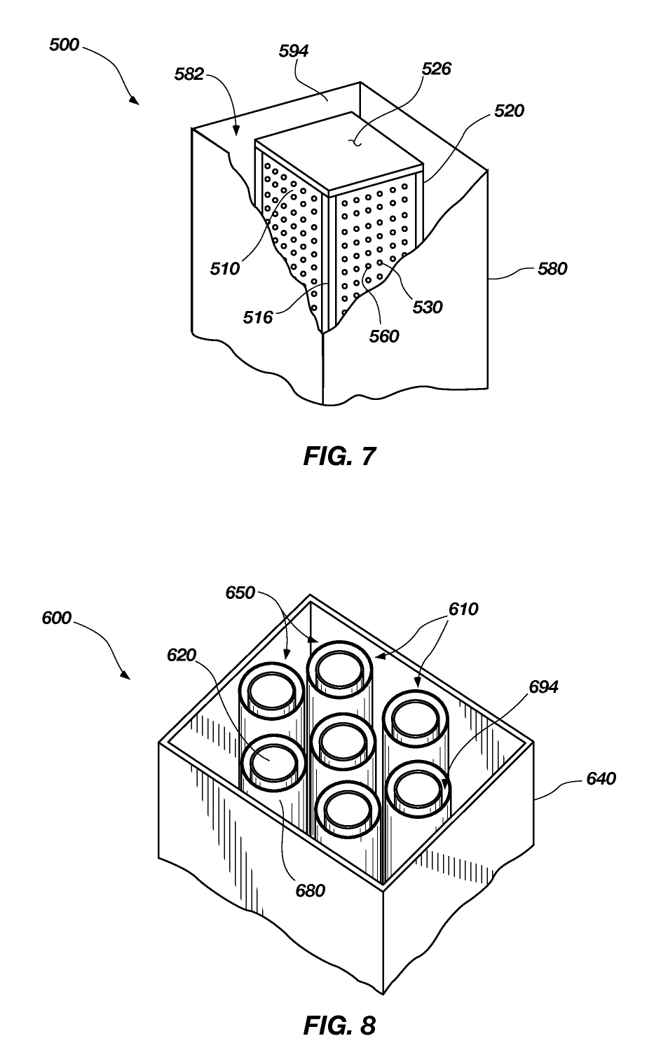

Referring now to FIG. 7, illustrated therein is a cut-away perspective view of an electrospray dispensing system 500 having a non-round elongate fluid supply cylinder 520, in accordance with another representative embodiment. The sidewall of the non-round fluid supply cylinder 520 is configured to form a polygonal cross-section having a plurality of substantially planar and multi-layered base substrates 510 forming the sides thereof. The base substrates 510 can be joined together at the corners 516 and covered with a cap 526 to form an interior hollow (not shown) which can be in fluid communication with a source of conductive fluid. Furthermore, each multi-layered base substrate 510 can have a plurality of selectively-activated capillary tubes 560 formed therein for delivering the controllable quantity of charged micro-droplets of a conductive fluid. In one additional aspect, the base substrate sections 510 can also include a plurality of gas duct openings 530 that are located within and around the plurality of capillary tubes 560 to provide the outwardly-directed jets of compressed air or gas that are substantially parallel with the outwardly-project streams of charged micro-droplets.

With the fluid supply cylinder 520 having a non-round or polygonal cross-section, the grounding electrode 580 can also comprises a polygonal cross-section matching the cross-section of the fluid supply cylinder and spaced apart at the predetermined distance from the capillary tubes 560, so as to maintain a constant spacing from the distal ends of the capillary tubes or distal tips of the guide wires. Moreover, the polygonal grounding electrode 580 can further comprises an elongate polygonal body or shell surrounding the polygonal fluid supply cylinder and forming an injector passage 582 having an polygonal-shaped open end 594, and wherein a source of compressed air can be fluidly coupled to the polygonal-shaped injector passage and configured to blow the charged micro-droplets out the open end 594.

In the various aspects of the electrospray dispensing system described herein, the internal diameter of the capillary tubes can range in size from about 50 μm to about 200 μm, while the diameter of the solid guide wires (if applicable) can range in size from about 25 μm to about 100 μm. Moreover, the predetermined distance between the grounding electrode and the distal ends of the capillary tubes or distal tips of the solid guide wires can range from about five millimeters to about twenty millimeters.

It is to be appreciated, therefore, that the amount of conductive fluid provided by any one capillary tube can be quite small, and that a large number of capillary tubes may be utilized to provide significant quantities of the charged micro-droplets that can rapidly evaporate into vapor. Consequently, as illustrated in FIG. 8, in one aspect the various assemblies 610 of elongate fluid supply cylinders 620 and grounding electrodes 680 as described above can be packaged together in one or more open-ended enclosures 640 to form an electrospray dispensing system 600 which can selectively deliver significant and controllable quantities of charged micro-droplets of a conductive fluid from a plurality of injector passage openings 694. Moreover, each representative supply cylinder/grounding electrode assembly 610, whether cylindrical or polygonal in cross-section, can be selectively activated individually or in combination with another supply cylinder/grounding assembly 610, and can further include a scalable array 650 of capillary tubes which themselves can be selectively-activated, whether individually or in groups or banks of capillary tubes, for delivering the micro-droplets in precise incremental amounts.

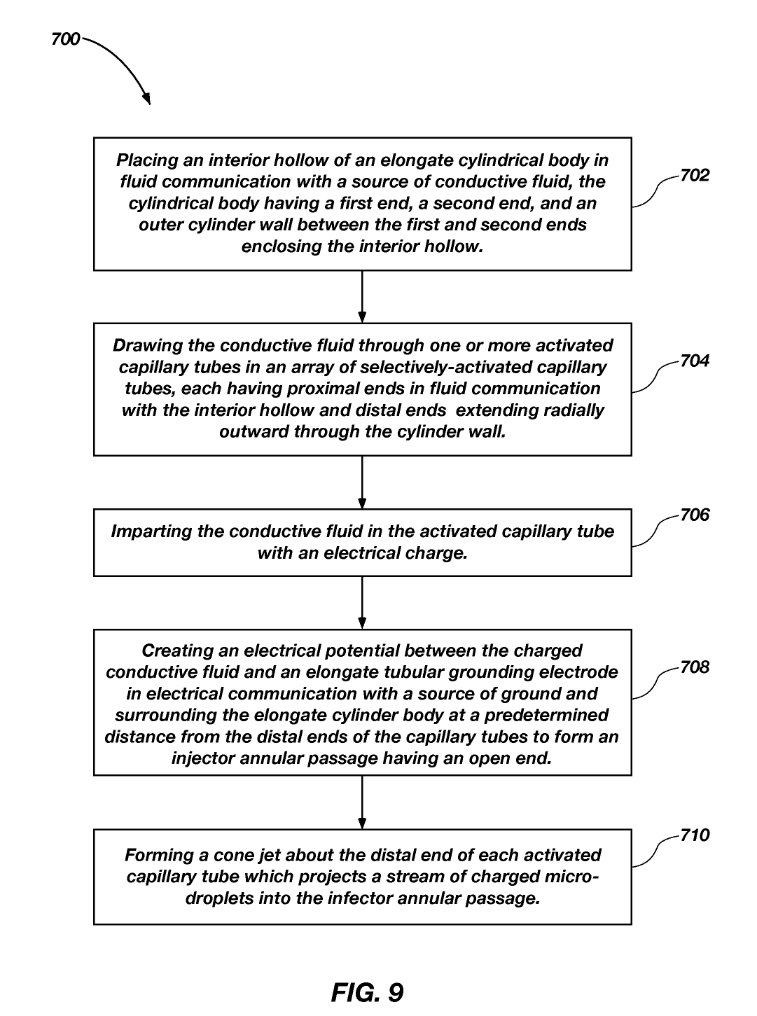

FIG. 9 is a flowchart depicting a method 700 for delivering a controllable quantity of charged micro-droplets of a conductive fluid, which method 700 includes placing 702 an interior hollow of an elongate cylindrical body in fluid communication with a source of conductive fluid, with the cylindrical body having a first end, a second end, and a sidewall extending between the first and second ends enclosing the interior hollow. The method also includes drawing 704 the conductive fluid through one or more activated capillary tubes in an array of selectively-activated capillary tubes, each having proximal ends in fluid communication with the interior hollow and distal ends extending radially outward through the sidewall, and imparting 706 the conductive fluid in the activated capillary tube with an electric charge. The method further includes creating 708 an electric potential between the charged conductive fluid and an elongate tubular grounding electrode that is in electrical communication with a source of ground and surrounding the elongate cylinder body at a predetermined distance from the distal ends of the capillary tubes, to form an injector annular passage having an open end. The method also includes forming 710 a cone jet about the distal end of each activated capillary tube that projects a stream of charged micro-droplets into the injector annular passage.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function limitation are expressly recited in the description herein. Accordingly, the scope of the invention should be determined solely by the appended claims and their legal equivalents, rather than by the descriptions and examples given above.

What is claimed and desired to be secured by Letters Patent is:

1) An electrospray dispensing system for delivering a controllable quantity of charged micro-droplets of a conductive fluid, comprising:
an elongate fluid supply cylinder having a first end, a second end, a sidewall between the first and second ends and an interior hollow in fluid communication with a source of conductive fluid;
an array of selectively-activated capillary tubes having proximal ends in fluid communication with the interior hollow and distal ends extending radially through the sidewall, and wherein the conductive fluid flowing outwardly through at least one activated capillary tube is electrically-charged; and
a grounding electrode in electrical communication with a source of ground and located at a predetermined distance from the distal ends of the capillary tubes,
wherein an electric potential between the charged conductive fluid and the grounding electrode causes the at least one activated capillary tube to form a cone jet projecting a stream of charged micro-droplets towards the grounding electrode.

2) The electrospray dispensing system of claim 1, wherein the grounding electrode further comprises an elongate tubular body surrounding the elongate fluid supply cylinder and forming an injector annular passage having an open end.

3) The electrospray dispensing system of claim 2, further comprising a source of compressed air in fluid communication with the injector annular passage and configured to blow the charged micro-droplets out the open end of the injector annular passage.

4) The electrospray dispensing system of claim 1, further comprising a tubular insert slidably located within the interior hollow of the fluid supply cylinder and configured to selectively displace to uncover the proximal end of the at least one selectively-activated capillary tube to activate the capillary tube.

5) The electro spray dispensing system of claim 1, wherein at least one of the source of conductive fluid and the array of the capillary tubes is in electrical communication with a high-voltage source.

6) (canceled)

7) (canceled)

8) The electro spray dispensing system of claim 1, wherein at least one of the capillary tubes further comprises a solid guide wire disposed at least partially within the capillary tube to form a nozzle annular passage therein and having a distal tip projecting beyond the distal end of the capillary tube.

9) The electro spray dispensing system of claim 8, wherein at least two of the guide wires are in separate selectively-actuatable electrical communication with a high-voltage source.

10) The electrospray dispensing system of claim 1, wherein the activated capillary tube has an internal diameter of less than or about two hundred micrometers.

11) The electro spray dispensing system of claim 1, wherein the stream of charged micro-droplets comprises a plurality of substantially mono-sized micro-droplets being sized between five and thirty micrometers in diameter.

12) The electrospray dispensing system of claim 1, wherein the predetermined distance between the grounding electrode and the distal ends of the capillary tubes ranges from about five millimeters to about twenty millimeters.

13) The electrospray dispensing system of claim 1, wherein the grounding electrode further comprises a grounding grid having an array of apertures aligned with the array of capillary tubes.

14) (canceled)

15) The electro spray dispensing system of claim 1, wherein the source of conductive fluid is provided with a modulated hydrostatic pressure for controlling a flowrate of the conductive fluid through the activated capillary tube.

16) The electro spray dispensing system of claim 1, wherein the sidewall of the fluid supply cylinder forms a polygonal cross-section having a plurality of substantially planar substrates forming the sides thereof, wherein at least one of the plurality of substantially planar substrates further comprises a multi-layered substrate having a plurality of capillary passages formed therein, and wherein the grounding electrode further comprises a polygonal cross-section matching the cross-section of the sidewall and spaced apart at the predetermined distance from the distal ends of the capillary tubes.

17) (canceled)

18) (canceled)

19) The electrospray dispensing system of claim 1, further comprising at least one gas passage formed within the sidewall that operates with the array of capillary tubes, to provide at least one outwardly-directed flow of gas substantially parallel to and adjacent the cone jet and stream of charged particles.

20) The electro spray dispensing system of claim 1, wherein at least one of the outer surface of at least one of the capillary tubes and the fluid supply cylinder is coated with a wetting resistant coating with respect to the conductive fluid, and wherein the inside surface of at least one capillary tube is coated with a coating to facilitate wetting of the inside surface by the conductive fluid.

21) (canceled)

22) (canceled)

23) An electrospray dispensing system for delivering a controllable quantity of charged micro-droplets of a conductive fluid, comprising:
a base substrate having a plurality of selectively-activated electrospray nozzles formed therein, at least one electro spray nozzle further comprising:
a capillary tube formed through the base substrate having a proximal end in fluid communication with a source of conductive fluid, and a distal end;
a solid guide wire coaxially disposed at least partially within the capillary tubes to form an annular passage, and having a distal tip projecting beyond the distal end of the capillary tube; and
at least one of the capillary tube and guide wire being conductive and in electrical communication with a high-voltage source to electrically charge the conductive fluid flowing through the annular passage; and
a grounding electrode in electrical communication with a source of ground and located a predetermined distance from the distal tip of the guide wire,
wherein a voltage differential between the charged conductive fluid and the grounding electrode draws the charged fluid away from the distal end of the activated capillary tube to form a cone jet about the distal tip of the guide wire projecting an outwardly-directed stream of charged micro-droplets.

24) The electrospray dispensing system of claim 23, wherein the base substrate further comprises a sidewall forming an elongate cylindrical body also having a first end, a second end, and an interior hollow in fluid communication with a source of conductive fluid.

25) The electrospray dispensing system of claim 24, wherein the grounding electrode further comprises an elongate tubular body surrounding the elongate cylindrical body to form an injector annular passage having an open end.

26) The electrospray dispensing system of claim 25, further comprising a source of compressed air in fluid communication with the injector annular passage and configured to blow the charged micro-droplets out the open end of the injector annular passage.

27) A method for delivering a controllable quantity of charged micro-droplets of a conductive fluid, comprising:
placing an interior hollow of an elongate cylindrical body in fluid communication with a source of conductive fluid, the cylindrical body having a first end, a second end, and a sidewall between the first and second ends enclosing the interior hollow;
drawing the conductive fluid through at least one activated capillary tube in an array of selectively-activated capillary tubes having proximal ends in fluid communication with the interior hollow and distal ends extending radially outward through the sidewall;
imparting the conductive fluid in the activated capillary tube with an electric charge;
creating an electric potential between the charged conductive fluid and an elongate tubular grounding electrode in electrical communication with a source of ground and surrounding the elongate cylinder body at a predetermined distance from the distal ends of the capillary tubes to form an injector annular passage having an open end; and
forming a cone jet about the distal end of the activated capillary tube projecting a stream of charged micro-droplets into the injector annular passage.

28) (canceled)

29) (canceled)

30) (canceled)

31) (canceled)
